(19) United States
(12) Patent Application Publication
(10) Pub. No.: US 2001/0047269 A1
(43) Pub. Date: Nov. 29, 2001

(54) Scanning invention process

(76) Inventor: John E. Cronin, Milton, VT (US)

Correspondence Address: Attention: Ryan K. Simmons, Esq., IPCapital Group, Inc., Suite 325, 400 Cornerstone Drive, Williston, VT, 05495, US

(21) Appl. No.: 09/766,456

(22) Filed: Jan. 19, 2001

Related U.S. Application Data
(60) Provisional application No. 60/179,675, filed on Feb. 2, 2000.

(51) Int. Cl. G06F 17/60

(52) U.S. Cl. 705/1; 705/7

(57) ABSTRACT

A method of identifying a full range of patentable aspects of an invention, the invention including broad and narrow aspects and includes the following steps. First, defining a first aspect of the invention, defining a first invention type of the invention, and defining a life cycle aspect of the invention. Second, modifying the first aspect while holding constant the first invention type and the life cycle aspect. Third, repeating the first and second steps until all the patentable aspect of the invention is defined.

### FIELD OF THE INVENTION

The present invention pertains to a business process for interviewing potential inventions from an individual or group, and documenting these inventions in a systematic way to define the potential intellectual property space that the inventions cover.

### BACKGROUND OF THE INVENTION

### Invention Process as a Creative Process

Invention has been a process used by mankind since the dawn of time. Invention has been used to create change in our socio economic systems, our technological improvements, our never-ending product developments and in enhancements scientific understandings. There have been many research studies on the process of invention. Some of these research projects have focused on the creative aspects of the inventor or inventors working in teams. Other research projects have focused on methods inventors use to create prototypes of their inventions.

### Invention Process as a Legal Property Process

Ever since the adoption of the Constitution of the United States of America, this country has allowed for legal rights of exclusion for patentable inventions. What grew out of single constitutional right has grown into an enormous body of laws, rules, regulations and procedures around inventions as patents. The legal process for prosecuting patents is bestowed to patent attorneys and patent agents who may engage in “patent practice” between an inventor (or assignee) and the United States Patent and Trademark Office (USPTO) Patent attorneys or patent agents must pass a federally administered exam to become a member of the patent bar. This examines, ones knowledge of patent law and knowledge of claim drafting. After passing this exam, almost all of the process for interacting with inventors is either done as “learn as you go” or as an apprentice of other patent law practitioners. There are very few courses on how to work with the inventive mind of the inventor, and apparently no courses that teach systematic methods to interact with the inventor to extract inventions from the inventor. Moreover, there are no systematic methods practiced to date that are directed to expanding the scope of an invention to its limits.

### Invention Software Tools for Extracting Details of an Invention

There are software tools that are on the market today that are used by attorneys and inventors to document inventions or to help assist the inventor in identifying his invention. One software tool, for example, is Patent Pro. Patent Pro guides an inventor through a set of questions that creates a patent draft application. One limitation of this tool is that it presumes the inventor has already determined that he/she has an invention. If the inventor is not knowledgeable about what constitutes patentable subject matter, they may still use such tools as Patent Pro to create a patent draft application.

### SUMMARY OF THE INVENTION

In general, in one aspect, the invention features a method of identifying a full range of patentable aspects of an invention where the invention may have broad and narrow aspects and includes the following steps. First, defining a first aspect of the invention, defining a first invention type of the invention, and defining a life cycle aspect of the invention. Second, modifying the first aspect while holding constant the first invention type and the life cycle aspect. Third, repeating the first and second steps until all the patentable aspect of the invention is defined.

The method of identifying a full range of patentable aspects of an invention where the invention may have broad and narrow aspects may further include the following steps. Fourth, selecting a new invention type different from the first invention type. Fifth iterating the second and third steps. Sixth, iterating the fourth and fifth steps until all new invention types are exhausted.

The method of identifying a full range of patentable aspects of an invention where the invention may have broad and narrow aspects may alternatively include the following steps. Fourth, electing a new life cycle aspect of the invention. Fifth, iterating the second and third steps. Sixth, iterating the fourth and fifth steps until all new life cycle aspects of the invention are covered.

Implementations of the invention may include one or more of the following features. Defining the first aspect of the invention may include at least one of the following; drawing a picture of the invention, defining elements of the picture, defining a technical problem solved by the invention, defining a business problem solved by the invention, defining impossible problems solved by the invention, defining technology used by the invention, defining products created by the invention, and/or defining a science needed to support the technology.

Modifying the first aspect of the invention may include asking “why” type questions leading to the broad aspects of the invention, and asking “how” type questions leading to the narrow aspects of the invention. The first aspect of the invention may be technical problem of the invention and by asking the “why” type questions will lead to a business problem of the invention. The first aspect of the invention may be a technical problem of the invention and by asking the “how” questions will lead to a scientific problem of the invention.

The first invention type may be selected from a group consisting of an apparatus, a method, an article of manufacture, a composition of matter, a functional invention, and a business process. The life cycle aspect of the invention may be one of the following the invention itself, a supplier who supplies a product or process to the invention and a user who uses the invention.

In general, in a second aspect, the invention features a method of identifying a full range of patentable aspects of an invention where the invention may have broad and narrow aspects and includes the following steps. First, defining a first aspect of the invention, selecting a first invention type of the invention and selecting a life cycle of the invention. Second, modifying the first invention type to a new invention type while holding the first aspect and the life cycle constant. Third, iterating the first and second steps until all new invention types are exhausted.

The method of identifying a full range of patentable aspects of an invention where the invention may have broad and narrow aspects may further include the following steps. Fourth, modifying the first aspect of the invention. Fifth, iterating the first and fourth step until the full range of patentable aspects of the invention is identified. Sixth, iterating the second through fifth step until all new invention types are exhausted.

Modifying of the first invention type may include selecting a second invention type from a group consisting of an apparatus, a method, an article of manufacture, a composition of matter, a functional invention, and a business process, the second invention type being different from the first invention type.

In general, in a third aspect, the invention features a method of identifying a full range of patentable aspects of an invention where the invention may have broad and narrow aspects, and includes the following steps. First, defining a first aspect of the invention, selecting a first invention type of the invention, and selecting a life cycle aspect of the invention. Second, modifying the life cycle aspect of the invention to a new life cycle aspect while holding constant the first aspect of the invention and the first invention type. Third, iterating the first and second steps until all new life cycle aspects are covered.

The method of identifying a full range of patentable aspects of an invention where the invention may have broad and narrow aspects may further include the following steps. Fourth, selecting a new invention type different from the first invention type. Fifth, iterating the first and fourth steps until all the new invention types of the invention are exhausted. Sixth, iterating the second through fifth steps until all new invention types are exhausted.

Modifying the life cycle may include asking what a supplier who supplies a product or a process to the invention may do once the invention is made, and the answer may be defined as an improvement to the invention. Modifying the life cycle may also includes asking what a user who uses the invention may do once the invention is made, and the answer may be defined as an extended invention of the invention.

In general, in a fourth aspect, the invention features a method of identifying a full range of patentable aspects of an invention where the invention may have broad and narrow aspects, and includes the following steps. First, defining a first aspect of the invention, selecting a first invention type of the invention, and selecting a life cycle aspect of the invention. Second, modifying the first aspect while holding constant the first invention type and the life cycle aspect. Third, iterating the second and third steps until the full range of patentable aspects of the invention is identified. Fourth, selecting a new invention type different from the first invention type. Fifth, iterating the second and third steps. Sixth, iterating the fourth and fifth steps until all new invention types are exhausted.

In general, in a fifth aspect, the invention features a method of identifying a full range of patentable aspects of an invention where the invention may have broad and narrow aspects, and includes the following steps. First, defining a first aspect of the invention, selecting a first invention type of the invention, and selecting a life cycle aspect of the invention. Second, modifying the life cycle aspect while holding constant the first invention type and the first aspect of the invention. Third, iterating the first and second steps until all life cycle aspects are covered. Fourth, modifying the first invention type to a new invention type. Fifth, iterating the second and third steps. Sixth, iterating the fourth and fifth steps until all new invention types are exhausted.

In general, in a sixth aspect, the invention features a method of identifying a full range of patentable aspects of an invention where the invention may have broad and narrow aspects, and includes the following steps. First, defining a first aspect of the invention, selecting a first invention type of the invention, and selecting a life cycle aspect of the invention. Second, modifying the first aspect of the invention while holding constant the first invention type and the life cycle. Third, iterating the first and second steps until the full range of patentable aspects of the invention is defined. Fourth, modifying the life cycle aspect of the invention. Fifth, iterating the second and third steps. Sixth, iterating the fourth and fifth steps until all life cycle aspects of the invention are covered.

In general, in a seventh aspect, the invention features a method of identifying a full range of patentable aspects of an invention where the invention may have broad and narrow aspects, and includes the following steps. First, defining a first aspect of the invention, selecting a first invention type of the invention, and selecting a life cycle aspect of the invention. Second, modifying the first aspect of the invention while holding constant the first invention type and the life cycle. Third, iterating the first and second steps until the full range of patentable aspects of the invention is defined. Fourth, modifying the first invention type to a new invention type. Fifth, iterating the second and third steps. Sixth, iterating the fourth and fifth steps until all new invention types are exhausted. Seventh, modifying the life cycle aspect of the invention. Eighth, iterating the second through seventh steps until all life cycle aspects of the invention are covered.

In general, in a eighth aspect, the invention features a method of training an inventor in identifying a full range of patentable aspects of an invention, and includes the following steps. First, educating the inventor on what constitutes a patentable invention. Second, educating the inventor on patentable invention subject matter concepts. Third, educating the inventor on what constitutes an invention type wherein the invention type is selected from a group consisting of an apparatus, a method, an article of manufacture, a composition of matter, a functional invention, and a business process. Fourth, educating the inventor on what constitutes an invention life cycle aspect wherein the life cycle aspect of the invention comprises one of the following the invention itself, a supplier who supplies a product or process to the invention and a user who uses the invention. Fifth, educating the inventor on an invention scanning process the scanning process comprising identifying a full range of patentable aspects of an invention.

In general, in a ninth aspect, the invention features a method of documenting a full range of patentable aspects of an invention, and includes the following steps. First, interviewing an inventor wherein the interview comprises capturing a title of the invention, a brief description of the invention, inventorship of the invention, and bar dates of the invention. Second, identifying a full range of patentable aspects of the invention. Third, recording the interview of the inventor. The recording may be accomplished by any one of the following paper and pencil, computer word processing, tape recorder, and video recorder.

In general, in an tenth aspect, the invention features a method of reducing a documented list of inventions to a minimal group of inventions needed to capture a defined intellectual property space wherein the intellectual property space is defined by an assignee's business strategy and business drivers, and includes the following steps. First, capturing the business strategy and business drivers of the assignee by interviewing the assignee. Second, comparing the business strategy and business drivers to the defined intellectual property space and the documented list of inventions. Third, selecting the inventions from the documented list of inventions, which capture the defined intellectual property space, the business strategy and the business drivers.

### BRIEF DESCRIPTION OF THE DRAWINGS

FIG. 1 is a description of the Ladder of Abstraction concept, with various points defined that demonstrate the “level” of an invention

FIG. 2 is a description of the “Scanning Area” or Product Life Cycle of an invention that describes the change in (a) the level of invention, (b) the type of invention and (3) the Life Cycle aspect of Views of the invention.

### DETAILED DESCRIPTION OF THE INVENTION

The present invention pertains to a business process of interviewing potential inventions from an individual or group, and documenting these inventions in a systematic way to define the potential intellectual property space that the inventions cover.

The present invention pertains to an overall scanning invention process that comprises the general steps of:

(1) a training means that train inventors on the specifics of what constitutes an invention from a patent perspective,

(2) a facilitated interaction (discussion and recording information) with the inventor that starts interviewing the inventor at his/her invention level,

(3) a facilitated means (discussion and recording information) to change the level of abstraction of the inventions,

(4) a facilitated means (discussion and recording information) for changing the invention type,

(5) a facilitated means (discussion and recording information) for changing the life cycle aspect of the invention or the,

(6) a facilitated iteration means (discussion and recording information) for iterating the level of abstraction, invention type and life cycle,

(7) a documentation means for both capturing the inventions from the interview in terms of (a) the title, (b) brief description of invention, (c) inventorship, (d) bar dates, (e) invention type, (f) invention life cycle or view, (g) IP strategy, (h) the level of invention and the (i) licensing value, (j) the area of invention as well as a means for sorting the scanned inventions.

(8) a decision means to reduce the documented list of inventions (generated by the documentation means) down to the minimal group of inventions needed to capture the intellectual property of the scanned invention space, based upon a business linkage means to line the reduced list to the business strategy of the inventor or assignee.

The following is a specific embodiment of each of the above-described individual steps of the process.

(1) Training Means

The training means is a facilitation and training session that trains inventors on the specifics of what constitutes an invention from a patent perspective. In order to start the invention scanning process, the inventor or group of inventors and/or their assignees are trained on basic important concepts of patentable inventions subject matter concepts. These concepts include but are not limited to:

a) the new, useful and non-obvious criteria of patentable inventions,

b) the concept of the ladder of abstraction,

c) the concept of bar dates of when an inventor is entitled to obtain a patentable invention,

d) the concept of publication as a means of obtaining freedom of action or of obtaining a low cost means of protected a basic invention by patenting the basic invention and publishing the incremental improvements around the basic invention,

e) the concept of inventorship,

f) the concept of invention types, that is, inventions fall into the categories types of an apparatus, a method, an article of manufacture, a composition of matter, a functional invention or a business process invention,

g) the concept of moving an invention type from an apparatus to also include the method of the invention, or the article that results from the method, etc,

h) the concept of invention views, that is, whether the invention is related to the inventors capability, their user of their invention or their supplier of needed components of their invention,

i) the concept of an IP strategy of their invention, that is, whether the invention should be (a) patented, (b) published with known inventors, (c) published anonymously, (d) held as trade secret, or other IP strategies like requiring more invention, etc.,

j) the concept of class of invention, that is, whether the invention is a breakthrough, distinctive or incremental. For this case, a set of criteria is developed with the inventors or assignees as to what meets the various class of inventions,

k) the concept of licensing value, that is, what would be the perceived dollar value of the invention,

l) the area of invention, that is, whether the invention is a technology, a basic technology or core competency based that is used to create all sorts of products or used as a basis for research and development, or a product or a business matter

(2) A Facilitation Means for Interviewing the Inventor at His/her Invention Level

The means of facilitation (discussion and recording information) comprises a trained individual who understands the scanning process and an inventor who is seeking to define what inventions the may have. The interviewing session involves questioning the inventor to understand what the inventor thinks their invention is; comprising the steps of:

(a) drawing a picture of the invention

(b) defining the elements of the picture

(c) defining the technical or business problems solved by the invention

(d) defining the impossible problems solved or to be solved,

(e) defining the technology used or planned on using,

(f) defining the products that have been created or are planned,

(g) defining the science needed to support the technology.

(3) Changing the “Level of Abstraction”

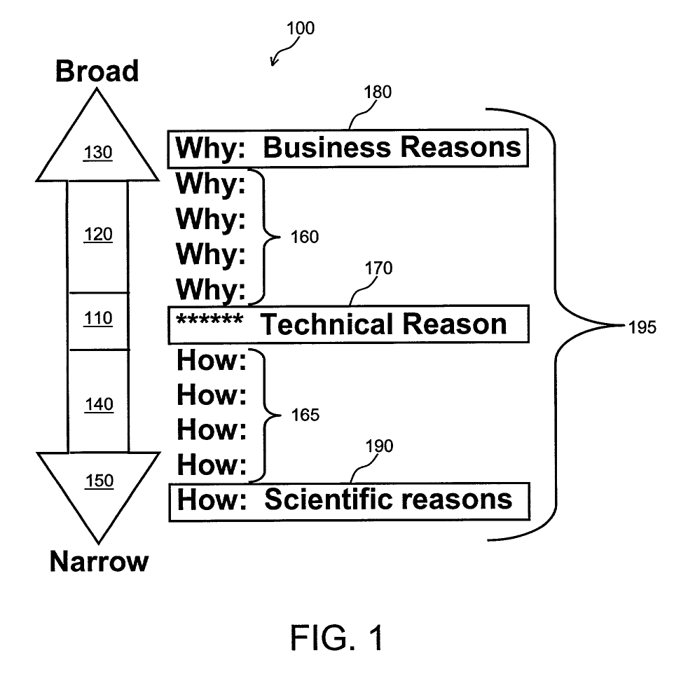

A description of a creativity tool called the “Ladder of Abstraction ” 100 is shown in FIG. 1. Point “A” 110 represents a starting point in any discussion. When the question of “why” 160 point “A” 110 is important is asked, the answer “B” 120 results in a broader concept than that at point “A” 110.

For example, point “A” 110 may represent a brief description of a dry erase marker invention, wherein the fluid in the dry erase marker could be viewed through a clear window along the side of the marker body. When asked why is this important, the answer “B” 120 is that a user has no idea when his marker has run out of fluid until he is using it in a presentation. This may lead to an improvement of the basic invention. For example, the clear window along the side of the dry erase marker body could have a scale that suggests the amount of marker usage left.

As shown in FIG. 1, when the question why is “B” 120 important is asked, the answer results in point “C” 130, which is a broader instantiation of point “B” 120.

For example, if point “B” 120 represents the improvement invention of marker scale along side the clear window on the dry erase marker, the question why this is important may lead to the answer “C,” 130 i.e., that the user needs to be able to predict marker fluid usage to avoid running out of fluid during a high need situation. This may lead to a further improvement of the invention, for example a secondary ink fluid reserve tank that allows a fixed short amount of writing time, and that uses a penetrable ink bladder activated by pressing a button on the dry erase pen handle.

If the starting point is a technical reason 170, then the series of “why” 160 questions will ultimately lead to a business reason 180, which is really a broader interpretation of the original technical reason 170, where in, as the higher level of the starting point is interpreted, the more inventions can solve the higher level needs.

Referring again to FIG. 1, starting at point “A” 110 and asking the question “how” 165 is point “A” 110 achieved, results to point “D” 140. The resultant point “D” 140 represents a lower level of detail than the original starting point.

For example, point “A” 110 may be a brief description of the dry erase marker invention, wherein the fluid in the dry erase marker could be viewed through a clear window along the side of the marker body. When asked how is point “A” 110 achieved, the answer “D” 140 is that the plastic mold has an open region associated with the window, into which a clear plastic window is added.

If point “D” 140 is used as the starting point to ask the question “how” 165 is point “D” 140 achieved, the resultant point “E” 150 results in a lower level of detail than point “D” 140.

For example, if point “D” 140 is the plastic mold that leaves an open region where the window will be defined and then the window region is filled with a clear plastic, the questions as to how is this achieved resultants in point “E” 150, which is that the second mold is formed only in the open region left by the first mold, and is filled with clear plastic.

If the starting point is a technical reason 170, then a series of “how” 165 questions ultimately lead to scientific reasons 190. Thus, using the ladder of abstraction 100, any starting point can be taken and different “levels of invention” 195 defined.

At a starting point, an inventor discussing his/her invention usually describes the technical problem solved, or the technical solution to the technical problem, or both. By asking a series of “why” 160 questions, higher levels of integration of their invention can be found that fit into a larger system or other applications. If the “why” 160 questions are further queried, a business system will eventually be found. Therefore, that business system may be patentable as a business process.

At a starting point, an inventor discussing his/her invention usually describes the technical problem solved, or the technical solution or both. By asking a series of “how” 165 questions, we will find a more detailed description of the critical parts of the invention that will cover the best mode or embodiment. By further asking “how” 165 questions; scientific reasons 190 may ultimately be reached. Many times scientific reasons 190 are not patentable; however, if scientific reasons 190 are uncovered, a it is likely that the lowest level embodiments were “passed through” and therefore, the quality of the result is that all “levels of embodiments” are uncovered.

(4) Facilitated Means for Changing the Invention Type

The “claims” of an invention fall into the categories types as defined by the USPTO. These types include an apparatus (product), a method (process), an article of manufacture, a composition of matter, a functional invention or a business process invention. Also, it is possible to have “mixed” claims that are a product by process, etc.

In the facilitation method, the facilitator, in interacting with the inventor, uses the following steps of:

(a) defining the invention,

(b) defining the type of invention,

(c) recording the first invention type,

(d) modifying the type of the invention to see if the invention is capable of having an additional invention type,

(e) recording the next invention type,

(f) iterating through steps (d) and (e) until all the types are exhausted.

For example, the facilitator asks the inventor for a brief description of the invention. For example, if the brief description of the invention is: a dry erase marker where the fluid in the dry erase marker could be viewed through a clear window along the side of the marker body, the facilitator would define this invention as an article of manufacture. This invention would be captured in a list.

Next the facilitator asks whether the dry erase marker where the fluid in the dry erase marker could be viewed through a clear window bring to mind a method (process). After some thinking and discussion, the inventor agrees that the method of obtaining the clear view window is novel, and therefore the method is recorded.

Next the facilitator asks whether the dry erase marker where the fluid in the dry erase marker could be viewed through a clear window bring to mind an apparatus. After some thinking, the inventor clearly sees that the apparatus that is used to make a double molded dry erase marker handle is novel, and therefore that is recorded.

Next the facilitator asks whether the dry erase marker where the fluid in the dry erase marker could be viewed through a clear window brings to mind a composition of matter. After some thinking, the inventor does not see a novel composition of matter.

Next the facilitator asks whether the dry erase marker where the fluid in the dry erase marker could be viewed through a clear window bring to mind a business process. After some thinking the inventor does not see a business process.

Finally, the facilitator asks whether the dry erase marker where the fluid in the dry erase marker could be viewed through a clear window brings to mind a functional invention. (A functional invention is a “test” that is defined by the inventor in which his/her invention passes the test, and his/her invention is the only invention that passes this test. Because of this, no matter what the apparatus or method is used to create the result; the functional invention will cover it.) After some thinking the inventor does not see a functional invention.

(5) A Facilitated Means for Changing the Life Cycle Aspect of the Invention

The life cycle aspects of an invention fall along a continuum. When an inventor invents a product or process, there is usually a supplier who supplies a product or process to the inventor's invention, that may be novel and patentable, and there may be a user who uses the inventor's invention.

In the facilitation method, the facilitator in interacting with the inventor uses the following steps:

(a) defining the business area of the inventor, that is, what is the inventors capability,

(b) defining the supplier business area of the inventors invention,

(c) defining the users business area of the inventors invention,

(d) defining the invention,

(e) recording the invention,

(f) modifying the life cycle aspect of the invention,

(g) iterating through (d) (e) and (f).

For example, the facilitator asks the inventor a brief description of the invention. For example, if a brief description of an invention is a dry erase marker where the fluid in the dry erase marker could be viewed through a clear window along side of the marker bodyI, the facilitator defines this as an area of his business, that is, the business of making and selling enhanced dry erase markers.

Next, the inventor is asked what the supplier to his invention might do once the invention is made. The inventor foresees that the supplier of the ink of the marker may design the ink to be more easily viewed through the clear plastic region. Therefore, the inventor defines this as an improvement to his invention.

Next, the inventor is asked what the user of his improved invention might do once the invention is made. The inventor foresees that the packaging of the new dry erase marker may be modified to show the clear window, and therefore the inventor may define this as his/her extended invention.

Since each user has another user, and every supplier has their supplier, the questions are continually asked by the facilitator until the life cycle continuum is completely explored.

(6) A Facilitated Iteration Means for Iterating the Level of Abstraction, Invention Type and Life Cycle.

The facilitator interviews the invention by systematically changing the level of abstraction, the invention type and the life cycle. Though one example of this process is described, it will be apparent that there are numerous ways to iterate through the steps, which include:

(a) defining the starting level of abstraction, defining the invention type, and defining the life cycle aspects of the invention and documenting this invention,

(b) modifying the level of abstraction by holding constant the invention type and the life cycle, and documenting this invention,

(c) iterating steps (a) through (b) until all the levels of abstraction are exhausted,

(d) modifying the type of invention to a new type and documenting this invention,

(e) iterating step (b) and step (c),

(f) iterating step (d) and (e) until all invention types are exhausted,

(g) modifying the life cycle aspect, and documenting the invention,

(h) iterating steps (b) through (g) until all the life cycle aspects of the invention are covered.

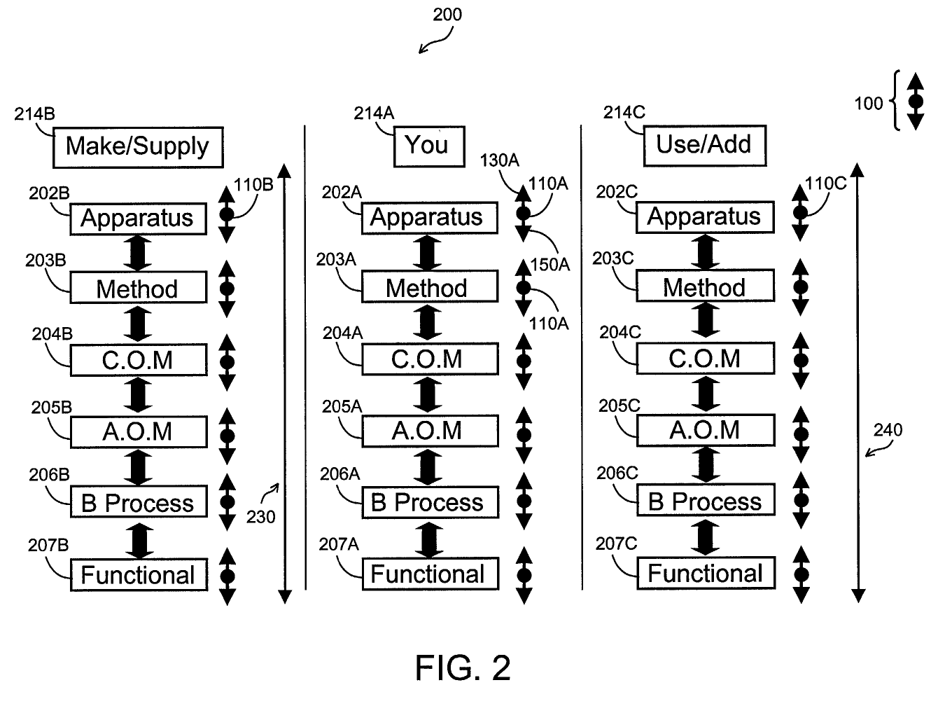

Shown in FIG. 2 is a “Scanning Area” 200, i.e., the space that can be intellectually scanned for inventions. Shown in FIG. 2 is the entire ladder of abstraction 100 (shown and described in FIG. 1), invention types 202A-207A, 202B-207B, 202C-207C and life cycle aspects 214A, 214B, 214C. The facilitator enters at a given point, in this example, an apparatus type invention 202A at level 110A of ladder of abstraction 100. By modifying level 110A, the facilitator helps to define various new inventions leading to level 130A and level 150A of ladder of abstraction 100.

After the levels of ladder of abstraction 100 is exhausted, the facilitator modifies the invention type 202A to the next invention type 203A, and enters at level 110A ladder of abstraction 100 for invention type 203A. Again (not shown in FIG. 2) the facilitator moves up and down the levels of ladder of abstraction 100. The facilitator continues the process, moving through the different invention types 202A-207A (and the levels of ladder of abstraction 100 within each invention type 202A-207A, until all invention types, and ladder of abstraction 100 levels within the invention types 202A-207A is exhausted.

The facilitator returns to level 110A of invention type 202A, and then moves the inventor to a new life cycle aspect (the supplier) 214B at ladder of abstraction 100 level 110B of invention type 202B. Once this new life cycle aspect 214B is defined, and inventions defined (if any) the facilitator moves the discussion up and down the ladder of abstraction 100 levels within the invention type 202B and then changes the invention type 202B (modifying the ladder of abstraction 100 within the type) until all invention types 202B-207B and the ladder of abstraction 100 levels of each invention within the invention types 202B-207B are exhausted. This is shown diagramatically as arrow 230 in FIG. 2.

After this life cycle aspect 214B is captured, the facilitator moves the discussion back to level 110A of invention type 202A to clarify the starting point of the discussion. The facilitator moves the discussion to the next life cycle aspect (the user), 214C at ladder of abstraction 100 level 110C of invention type 202C and determines if there is a new invention. The facilitator moves the discussion up and down the levels of ladder of abstraction 100 within the invention type 202C and then changes the invention type 202C (modifying the ladder of abstraction 100 levels within the invention type) until all invention types 202C-207C and levels of the ladder of abstraction 100 within the invention types 202C-207C are exhausted. This is shown diagramatically as arrow 240 in FIG. 2.

It should be noted that an experienced facilitator knows that every user has another user and every supplier has a supplier, and that the facilitator can continue the move across the life cycle until such time as the inventor can no longer practically suggest concepts of the new life cycle area, since the technical knowledge of the inventor is limited.

(7) Documentation Means for Both Capturing the Inventions from the Interview in Terms of (a) the title, (b) brief description of invention, (c) inventorship, (d) bar dates, (e) invention type, (f) invention life cycle or view, (g) IP strategy, (h) the level of invention and the (i) licensing value, (j) the area of invention as well as a means for sorting the scanned inventions.

The facilitator, using any recording means (e.g., paper and pencil, computer word processing, tape recorder, video recorder) to capture the inventions, at each level, each type and each aspect of the life cycle continuum.

The facilitator, in interacting with the inventor, needs to capture minimally the invention title and brief description, bar dates, inventorship, and where in the Scanning Area the invention lies. That is, what the invention is, is it at a higher or lower level, what the type of invention is and what the life cycle aspect is.

For example, if a brief description of an invention were a dry erase marker where the fluid in the dry erase marker could be viewed through a clear window along the side of the marker body, the facilitator would define the following:

| | |
|---|---|
| Title = | “Clear Viewing of Dry Erase Marker Fluid” |
| Description = | “The body of the marker has a region along its |
| | length that is clear, allowing the user of the marker |
| | to see how much dry erase marker fluid is left” |
| Level = | distinctive (from choices of Breakthrough, |
| | Distinctive, Incremental) |
| Type = | Apparatus (from choices of method, apparatus, |
| | article of manufacture, composition of matter, |
| | functional or business process) |
| Life Cycle = | Your Capability (from choices of your capability, |
| | user, supplier) |
| Inventor = | John Doe |
| Dates = | bar date 1/1/2001 |

Optionally, the facilitator would define other important groups of
information, for example;

| | |
|---|---|
| IP strategy = | File (from the list of File, Search, Publish, Invent |
| | Around, Invent in Front of, run an invention |
| | creation session, get expert opinion, etc) |
| Licensing value = | License to other (from the list of license to others, |
| | hold trade secret, etc) |
| Area of invention = | Product (from the list of Product, or technology) |

(9) A Decision Means to Reduce the Documented List of Inventions (Generated by the Documentation Means) Down to the Minimal Group of Inventions Needed to Capture the Intellectual Property of the Scanned Invention Space, Based upon a Business Linkage Means to Line the Reduced List to the Business Strategy of the Inventor or Assignee.

After the scanning list is defined, it needs to be shortened to a manageable level of inventions that may need to be documented and potentially filed as patent applications. This is accomplished by understanding the business drivers of the assignee as well as the patent ability strategy.

For example, if the assignee is worried about their suppliers, but not their users, they may decide to sort the list and only document those inventions that are related to their capability and the capability of the suppliers. Therefore any of the business related issues that are determined can be used to sort along the lines of life cycle, IP strategy, licensing Value etc.

For patentability issues, bar dates, and other legal questions, a patent attorney or agent can be consulted.

The many features and advantages of the present invention are apparent from the detailed specification. Thus, it is intended that the present invention cover all such features and advantages falling within the scope of the invention. Further, since numerous modifications and changes will readily occur to those of ordinary skill in the art, it is not desired to limit the invention to the exact constructions and operations illustrated and described above. Accordingly, all suitable modifications and equivalents should be considered as falling within the spirit and scope of the present invention.

What is claimed is:

1. A method of identifying a full range of patentable aspects of an invention said invention having broad and narrow aspects, the method comprising:
a) defining a first aspect of said invention, selecting a first invention type of said invention, and selecting a life cycle aspect of said invention;
b) modifying said first aspect of said invention while holding constant said first invention type and said life cycle aspect; and
c) iterating steps (a) and (b) until said full range of patentable aspects of said invention is identified.

2. The method of claim 1 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products created by said invention; and
h) defining a science needed to support said technology.

3. The method of claim 1 wherein said modifying said first aspect of said invention comprises:
a) asking “why” type questions leading to said broad aspects of said invention; and
b) asking “how” type questions leading to said narrow aspects of said invention.

4. The method of claim 3 wherein said first aspect of said invention is a technical problem of said invention and by asking said “why” type questions will lead to a business problem of said invention

5. The method of claim 3 wherein said first aspect of said invention is a technical problem of said invention and by asking said “how” questions will lead to a scientific problem of said invention.

6. The method of claim 1 wherein said first invention type is selected from a group consisting of an apparatus, a method, an article of manufacture, a composition of matter, a functional invention, and a business process.

7. The method of claim 1 wherein said life cycle aspect of said invention comprises one of the following said invention itself, a supplier who supplies a product or process to said invention and a user who uses said invention.

8. A method of identifying a full range of patentable aspects of an invention, said invention having broad and narrow aspects, the method comprising:
a) defining a first aspect of said invention, selecting a first invention type of said invention and selecting a life cycle of said invention;
b) modifying said first invention type to a new invention type while holding said first aspect and said life cycle constant; and
c) iterating steps (a) through (b) until all new invention types are exhausted.

9. The method of claim 8 wherein said first invention type is selected from a group consisting of an apparatus, a method, an article of manufacture, a composition of matter, a functional invention, and a business process.

10. The method of claim 8 wherein said modifying of said first invention type comprises selecting a second invention type from a group consisting of an apparatus, a method, an article of manufacture, a composition of matter, a functional invention, and a business process, said second invention type being different from said first invention type.

11. The method of claim 8 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

12. The method of claim 8 wherein said life cycle aspect of said invention comprises one of the following said invention itself, a supplier who supplies a product or process to said invention and a user who uses said invention.

13. A method of identifying a full range of patentable aspects of an invention said invention having broad and narrow aspects, the method comprising:
a) defining a first aspect of said invention, selecting a first invention type of said invention, and selecting a life cycle aspect of the invention;
b) modifying said life cycle aspect of said invention to a new life cycle aspect while holding constant said first aspect of said invention and said first invention type;
c) iterating steps (a) through (b) until all new life cycle aspects are covered; and
wherein said life cycle aspect of said invention comprises one of the following said invention itself, a supplier who supplies a product or process to said invention and a user who uses said invention.

14. The method of claim 13 wherein said modifying of said life cycle comprises asking what a supplier who supplies a product or a process to said invention may do once the invention is made, wherein an answer may be defined as an improvement to said invention.

15. The method of claim 13 wherein said modifying of said life cycle comprises asking what a user who uses said invention may do once the invention is made, wherein an answer may be defined as an extended invention of said invention.

16. The method of claim 13 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

17. The method of claim 13 wherein said first invention type is selected from a group consisting of an apparatus, a method, an article of manufacture, a composition of matter, a functional invention, and a business process.

18. The method of claim 1 further comprising:
d) selecting a new invention type different from said first invention type;
e) iterating said steps (b) and (c); and
f) iterating steps (d) and (e) until all new invention types are exhausted.

19. The method of claim 1 further comprising
d) selecting a new life cycle aspect of said invention;
e) iterating said steps (b) and (c); and
f) iterating steps (d) and (e) until all new life cycle aspects of said invention is covered.

20. The method of claim 8 further comprising:
d) modifying said first aspect of said invention;
e) iterating steps (a) and (d) until said full range of patentable aspects of said invention is identified; and
f) iterating steps (b) through (e) until all new invention types are exhausted.

21. The method of claim 13 further comprising:
d) selecting a new invention type different from said first invention type;
e) iterating steps (a) and (d) until all said new invention types of said invention are exhausted; and
f) iterating steps (b) and (e) until all new invention types are exhausted.

22. A method of identifying a full range of patentable aspects of an invention said invention having broad and narrow aspects, the method comprising:
a) defining a first aspect of said invention, selecting a first invention type of said invention, and selecting a life cycle aspect of the invention;
b) modifying said first aspect while holding constant said first invention type and said life cycle aspect.
c) iterating steps (a) and (b) until said full range of patentable aspects of said invention is identified;
d) selecting a new invention type different from said first invention type;
e) iterating steps (b) and (c); and
f) iterating steps (d) and (e) until all new invention types are exhausted.

23. The method of claim 22 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

24. The method of claim 22 wherein said modifying said first aspect of the invention comprises:
a) asking “why” type questions leading to broad aspects of said invention; and
b) asking “how” type questions leading to narrow aspects of said invention.

25. The method of claim 24 wherein said first aspect is a technical problem of said invention and by asking said “why” type questions will lead to a business problem of said invention.

26. The method of claim 24 wherein said first aspect is a technical problem and asking said “how” questions will lead to a scientific problem of said invention.

27. The method of claim 22 wherein said first invention type is selected from a group consisting of an apparatus, a method, an article of manufacture, a composition of matter, a functional invention, and a business process.

28. The method of claim 22 wherein said life cycle aspect of said invention comprises one of the following said invention itself, a supplier who supplies a product or process to said invention and a user who uses said invention.

29. A method of identifying a full range of patentable aspects of an invention said invention having broad and narrow aspects, the method comprising:
a) defining a first aspect of said invention, selecting a first invention type of said invention, and selecting a life cycle aspect of the invention;
b) modifying said life cycle aspect while holding constant said first invention type and said first aspect of the invention;
c) iterating steps (a) and (b) until all life cycle aspects are covered;
d) modifying said first invention type to a new invention type;
e) iterating steps (b) and (c); and
f) iterating steps (d) and (e) until all new invention types are exhausted.

30. The method of claim 29 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

31. The method of claim 29 wherein said first invention type is selected from a group consisting of an apparatus, a method, an article of manufacture, a composition of matter, a functional invention, and a business process.

32. The method of claim 29 wherein said life cycle aspect of said invention comprises one of the following said invention itself, a supplier who supplies a product or process to said invention and a user who uses said invention.

33. The method of claim 29 wherein said modifying of said life cycle comprises asking what a supplier who supplies a product or a process to said invention may do once the invention is made, wherein an answer may be defined as an improvement to said invention.

34. The method of claim 29 wherein said modifying of said life cycle comprises asking what a user who uses said invention may do once the invention is made, wherein an answer may be defined as an extended invention of said invention.

35. A method of identifying a full range of patentable aspects of an invention said invention having broad and narrow aspects, the method comprising:
a) defining a first aspect of said invention, selecting a first invention type of said invention, and selecting a life cycle aspect of the invention;
b) modifying said first aspect of the invention while holding constant said first invention type and said life cycle;
c) iterating steps (a) and (b) until said full range of patentable aspects of the invention is defined;
d) modifying said life cycle aspect of said invention;
e) iterating steps (b) and (c); and
f) iterating steps (d) and (e) until all life cycle aspects of said invention are covered.

36. The method of claim 35 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

37. The method of claim 35 wherein said modifying said first aspect of the invention comprises:
a) asking “why” type questions leading to broad aspects of said invention; and
b) asking “how” type questions leading to narrow aspects of said invention.

38. The method of claim 37 wherein said first aspect is a technical problem of said invention and by asking said “why” type questions will lead to a business problem of said invention.

39. The method of claim 37 wherein said first aspect is a technical problem of said invention and by asking said “how” questions will lead to a scientific problem of said invention.

40. The method of claim 35 wherein said first invention type is selected from a group consisting of an apparatus, a method, an article of manufacture, a composition of matter, a functional invention, and a business process.

41. The method of claim 35 wherein said life cycle aspect of said invention comprises one of the following said invention itself, a supplier who supplies a product or process to said invention and a user who uses said invention.

42. The method of claim 35 wherein said modifying of said life cycle comprises asking what a supplier who supplies a product or a process to said invention may do once the invention is made, wherein an answer may be defined as an improvement to said invention.

43. The method of claim 35 wherein said modifying of said life cycle comprises asking what a user who uses said invention may do once the invention is made, wherein an answer may be defined as an extended invention of said invention.

44. A method of identifying a full range of patentable aspects of an invention said invention having broad and narrow aspects, the method comprising:
a) defining a first aspect of said invention, selecting a first invention type of said invention, and selecting a life cycle aspect of the invention;
b) modifying said first aspect of the invention while holding constant said first invention type and said life cycle;
c) iterating steps (a) and (b) until said full range of patentable aspects of the invention is defined;
d) modifying said first invention type to a new invention type;
e) iterating steps (b) and (c);
f) iterating steps (d) and (e) until all new invention types are exhausted;
g) modifying said life cycle aspect of said invention; and
h) iterating steps (b) through (g) until all life cycle aspects of said invention are covered.

45. The method of claim 44 wherein said defining said first aspect of said invention comprises at least one of the following:
a) drawing a picture of said invention;
b) defining elements of said picture;
c) defining a technical problem solved by said invention;
d) defining a business problem solved by said invention;
e) defining impossible problems solved by said invention;
f) defining technology used by said invention;
g) defining products that have been created by said invention; and
h) defining a science needed to support said technology.

46. The method of claim 44 wherein said modifying said first aspect of the invention comprises:
a) asking “why” type questions leading to broad aspects of said invention; and
b) asking “how” type questions leading to narrow aspects of said invention.

47. The method of claim 46 wherein said first aspect is a technical problem of said invention and by asking said “why” type questions will lead to a business problem of said invention.

48. The method of claim 46 wherein said first aspect is a technical problem of said invention and by asking said “how” type questions will lead to a scientific problem of said invention.

49. The method of claim 44 wherein said first invention type is selected from a group consisting of an apparatus, a method, an article of manufacture, a composition of matter, a functional invention, and a business process.

50. The method of claim 44 wherein said life cycle aspect of said invention comprises one of the following said invention itself, a supplier who supplies a product or process to said invention and a user who uses said invention.

51. The method of claim 44 wherein said modifying of said life cycle comprises asking what a supplier who supplies a product or a process to said invention may do once the invention is made, wherein an answer may be defined as an improvement to said invention.

52. The method of claim 44 wherein said modifying of said life cycle comprises asking what a user who uses said invention may do once the invention is made, wherein an answer may be defined as an extended invention of said invention.

53. A method of training an inventor in identifying a full range of patentable aspects of an invention, the method comprising:
a) educating said inventor on what constitutes a patentable invention;
b) educating said inventor on patentable invention subject matter concepts;
c) educating said inventor on what constitutes an invention type wherein said invention type is selected from a group consisting of an apparatus, a method, an article of manufacture, a composition of matter, a functional invention, and a business process;
e) educating said inventor on what constitutes an invention life cycle aspect wherein said life cycle aspect of said invention comprises one of the following said invention itself, a supplier who supplies a product or process to said invention and a user who uses said invention; and
f) educating said inventor on an invention scanning process said scanning process comprising identifying a full range of patentable aspects of an invention.

54. A method of documenting a full range of patentable aspects of an invention, the method comprising:
a) interviewing an inventor wherein said interview comprises capturing a title of said invention, a brief description of said invention, inventorship of said invention, and bar dates of said invention;
b) identifying a full range of patentable aspects of the invention; and
c) recording said interview of said inventor.

55. The method of claim 54 wherein said recording is accomplished by any one of the following paper and pencil, computer word processing, tape recorder, and video recorder.

56. A method of reducing a documented list of inventions to a minimal group of inventions needed to capture a defined intellectual property space wherein said intellectual property space is defined by an assignee's business strategy and business drivers, the method comprising:
a) capturing said business strategy and business drivers of said assignee by interviewing said assignee;
b) comparing said business strategy and business drivers to said defined intellectual property space and said documented list of inventions; and
c) selecting said inventions from said documented list of inventions, which capture said defined intellectual property space, said business strategy and said business drivers.
